(19) United States
(12) Patent Application Publication
(10) Pub. No.: US 2011/0143231 A1
(43) Pub. Date: Jun. 16, 2011

(54) INTEGRATED PIPING MODULE IN FUEL CELL SYSTEM

(75) Inventor: Jin S. HEO, Suwon-si (KR)

(73) Assignee: Samsung Electronics Co., Ltd., Suwon-si (KR)

(21) Appl. No.: 12/952,383

(22) Filed: Nov. 23, 2010

(30) Foreign Application Priority Data
Dec. 11, 2009 (KR) 10-2009-0123394

(51) Int. Cl. H01M 8/06; H01M 8/04

(52) U.S. Cl. 429/413; 429/512; 429/434; 429/435

(57) ABSTRACT

An integrated piping module to connect a fuel cell and a fuel processor, the integrated piping module including: tanks to collect heat emitted from a reformate gas generated by the fuel processor, heat emitted from air discharged from the fuel cell, and water condensed from the reformate gas and/or the discharged air; pipes to heat and cool the reformate gas, and to remove the water from the tanks.

### CROSS-REFERENCE TO RELATED APPLICATIONS

This application claims the benefit of Korean Patent Application No. 10-2009-0123394, filed on Dec. 11, 2009, in the Korean Intellectual Property Office, the disclosure of which is incorporated herein in its entirety, by reference.

### BACKGROUND

1. Field

The present disclosure relates to apparatuses connecting a fuel cell and a fuel processor, and a fuel cell system including the same.

2. Description of the Related Art

A fuel cell is an environmentally-friendly energy technology that generates power using a hydrogen-containing fuel. A fuel currently supplied in the market, e.g., city gas, does not have a hydrogen density sufficient to be used in the fuel cell, and thus, it is necessary to use an apparatus to reform the city gas. In this regard, several pipes are arranged between the reforming apparatus and the fuel cell, so as to transport a reformate gas.

### SUMMARY

Provided are an integrated piping module and a fuel cell system having the integrated piping module applied thereto, whereby the number of parts that connect a fuel processor and a fuel cell may be decreased, and an amount of heat loss in the fuel cell system may be minimized.

According to an aspect of the present invention, an integrated piping module includes a first tank; an external pipe penetrating through the first tank, having a middle outlet for discharging a gas inside of the first tank; and an internal pipe formed in the external pipe, extending between the middle outlet and an outlet of the external pipe, to transport a gas from the first tank to a fuel cell. An outlet of the internal pipe is closer to an inlet of the external pipe than to the middle outlet of the external pipe. Water is condensed from the gas, via cooling of the gas in the first tank. The cooled gas is heated in the internal pipe, by the gas passing through the external pipe.

According to another aspect of the present invention, a fuel cell system includes a fuel processor to generate a reformate gas from a fuel; a fuel cell to convert a chemical energy of the reformate gas into electric energy; and an integrated piping module to remove water from the gas and to store heat. The piping module includes: tanks to collect heat emitted from the reformate gas and/or the fuel cell, and to collect water condensed from the reformate gas; and pipes to heat and cool the reformate gas, to discharge the water from the tanks, and to connect the piping module to the fuel processor and the fuel cell.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is a diagram of a configuration of a fuel cell system according to an embodiment of the present invention;

FIG. 2 is a cross-sectional view of an example of an integrated piping module of FIG. 1;

FIG. 3A to 3C illustrate examples of an external pipe and an internal pipe of FIG. 2;

FIG. 4 is a diagram of a structure in which a first tank is added to the example of FIG. 3A;

FIG. 5 is a diagram of a structure in which a cooler is added to the structure of FIG. 4;

FIG. 6 is a diagram of a structure in which a second tank is added to the structure of FIG. 5;

FIG. 7 is a diagram of a structure in which a third tank is added to the structure of FIG. 6; and

FIG. 8 is a diagram of a structure in which a fourth tank is added to the structure of FIG. 7.

### DETAILED DESCRIPTION

Reference will now be made in detail to the exemplary embodiments of the present disclosure, examples of which are illustrated in the accompanying drawings, wherein like reference numerals refer to the like elements throughout. The exemplary embodiments are described below, in order to explain the aspects of the present disclosure, by referring to the figures.

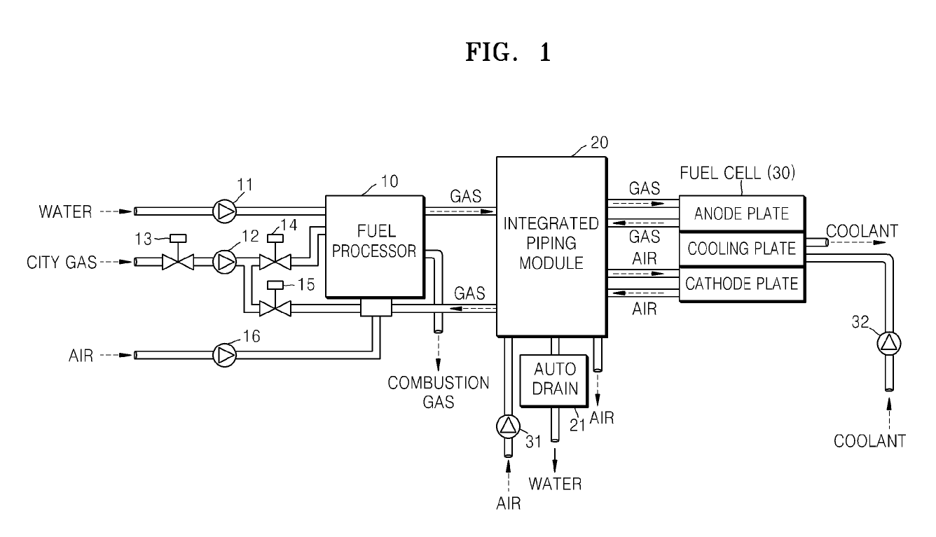

FIG. 1 is a diagram of a configuration of a fuel cell system, according to an embodiment of the present invention. Referring to FIG. 1, the fuel cell system includes a fuel processor 10, a fuel cell 30, and an integrated piping module 20 connecting the fuel processor 10 and the fuel cell 30.

The fuel processor 10 reacts a fuel and water to generate a reformate gas having a hydrogen density sufficient to be used in the fuel cell 30. Examples of raw materials for the reformate gas include city gas, liquefied propane gas (LPG), lamp oil, and the like. Currently, city gas is most often used to generate the reformate gas, and hereinafter, the present embodiment will be described with respect to the city gas. In the fuel processor 10, the reformation reaction of CH₄+H₂O→CO+3H₂ occurs between the city gas and the water, and simultaneously, the shift reaction of CO+H₂O→CO₂+H₂ generally occurs. With respect to the reformation reaction, when a temperature of a reformation catalyst is maintained at about 700° C., the hydrogen density of the reformate gas is sufficiently high. Accordingly, the city gas supplied to the fuel processor 10 is used in the reformation reaction and is simultaneously used for a burner to heat the catalyst of the reform reaction.

The fuel processor 10 is connected to a water pump 11 for supplying the water to the fuel processor 10. In general, the water supplied to the fuel processor 10 is deionized water. Also, the fuel cell processor 10 is connected to a city gas pump 12 for supplying the city gas to the fuel processor 10. An electronic valve 13, for adjusting the total amount of city gas to be supplied to the fuel processor 10, is inserted into a front end of the city gas pump 12. An electronic valve 14 for adjusting the amount of city gas for the reformate reaction and an electronic valve 15 for adjusting the amount of city gas for heating the catalyst of the reformate reaction, are disposed downstream from the city gas pump 12. Also, an air pump 16, for supplying air to the burner to combust the city gas, is connected to the fuel processor 10. Also, the fuel cell processor 10 is connected to an outlet for discharging a by-product formed when the city gas is combusted by the burner.

The fuel cell 30 generates power by using the reformate gas formed by the fuel processor 10. In more detail, the fuel cell 30 includes: a plurality of unit cells for directly converting a chemical energy of the reformate gas into electric energy, by electrochemically reacting hydrogen in the reformate gas with oxygen in air; a cooling plate for cooling the cells; and the like. Each of the cells includes an anode plate to which the reformate gas is supplied, a proton exchange membrane that is selectively permeable to protons separated from the hydrogen, and a cathode plate to which an oxidant is supplied, such as oxygen in air.

As described above, the fuel cell 30 includes a stack of unit cells. However, in order to simply illustrate the fuel cell 30, only one anode plate, cooling plate, and cathode plate are illustrated in FIG. 1. However, it will be understood by one of ordinary skill in the art that the fuel cell 30 may be formed of stacked unit cells, including pluralities of cathode plates, cooling plates, and anode plates, and that the present embodiment may be applied to each of the stacked unit cells.

According to the related art, a plurality of pipes for transporting the reformate gas, a plurality of solenoid valves for controlling a flow of the reformate gas, a plurality of drain separators for separating water from the reformate gas, and a plurality of auto drains for discharging the water separated by the drain separators out of the fuel cell system, are arranged between the fuel processor 10 and the fuel cell 30. Since the reformate gas discharged from the fuel processor 10 includes water, the water interferes with the flow of the reformate gas within the pipes. As a result, an insufficient amount of the reformate gas may be supplied to the fuel cell 30, and this insufficiency may interfere with power generating by the fuel cell 30.

According to the related art, in order to remove the water in the pipes, the drain separators and the auto drains are arranged in several places along the pipes. In this regard, the arrangement of the drain separators and the auto drains complicates the configuration of the pipes. While the reformate gas discharged from the fuel processor 10 passes through the pipes, the reformate gas emits heat, and thus, the reformate gas is cooled. Due to the increased length and complicated configuration of the pipes, the possibility of a leak increases, and the reformate gas may be cooled below an optimal temperature for use in the fuel cell 30. These are factors that affect a performance and a durability of the fuel cell 30.

The integrated piping module 20 has tanks for collecting heat emitted from the reformate gas, heat emitted from the fuel cell 30, and condensed water. The integrated piping module 20 includes one or more pipes for removing and discharging water from the tanks. Here, a tank for collecting the heat emitted from the reformate gas and another tank for collecting the heat emitted from air discharged from the fuel cell 30 may be separately arranged in the integrated piping module 20. Also, a pipe for removing the water from the reformate gas in the tanks and the heat emitted from the air discharged from the fuel cell 30, and another pipe for heating the reformate gas after the water is removed, may be separately arranged in the integrated piping module 20.

The integrated piping module 20 does not include a conventional complicated pipe configuration and instead, is simply formed as a tank. As such, the number of parts of the fuel cell system may be reduced, the possibility of leaks may be reduced, and heat loss may be minimized. Also, since the integrated piping module 20 has the tanks that collect heat, and pipes for heating and cooling the reformate gas, while condensing water from the reformate gas the reformate gas is hardly cooled. Thus, the reformate gas may be supplied to the fuel cell 30 with little heat loss and thus, may be supplied at a relatively high temperature. Due to the aforementioned configuration of the integrated piping module 20, it is possible for the fuel cell 30 to stably generate power, and thus, the performance and the durability of the fuel cell 30 may be improved.

Except for when the fuel cell 30 is operating at a temperature equal to or greater than about 500° C., when the reformate gas supplied to an anode inlet of the fuel cell 30 includes carbon monoxide (CO). Thus, a platinum-based electrode catalyst of the anode plate of the fuel cell 30 may be degraded. That is, according to an operation temperature of the fuel cell 30, a tolerance to CO increases, and in cases where the fuel cell 20 is operating at a temperature is about 150° C., a CO concentration in the reformate gas should be reduced to less than 0.5%. When the fuel processor 10 starts reforming the city gas in an initial operation stage, the reformate gas contains a relatively high concentration of CO, and the fuel cell system does not send the reformate gas to the fuel cell 30. Instead, the reformate gas is supplied to the burner, to heat the catalyst of the reformate reaction, until the CO concentration in the reformate gas is reduced to less than 0.5%. For this, a bypassing apparatus is arranged between the fuel processor 10 and the integrated piping module 20, so as to selectively supply the reformate gas to the fuel cell 30 or the burner, according to the CO concentration of the reformate gas.

The fuel cell system of FIG. 1 may be a fuel cell system in which the CO concentration in the reformate gas is already less than about 0.5%, when the fuel processor 10 initially reforms the city gas, and thus, may be designed to have a structure that does not include a bypassing apparatus. However, a bypassing apparatus (not shown) may further be arranged between the fuel processor 10 and the integrated piping module 20, so as to selectively supply the reformate gas to the integrated piping module 20, according to the CO concentration of the reformate gas. The bypassing apparatus may include a pipe for redirecting the reformate gas discharged from the fuel processor 10 back to the fuel processor 10, and an electronic valve for controlling a flow of the reformate gas in the pipe. Accordingly, the present embodiment may also be used in an environment in which the CO concentration in the reformate gas is equal to or greater than about 0.5%, when the fuel processor 10 starts reforming the city gas.

At least one auto drain 21 is connected to the integrated piping module 20, so as to externally discharge water condensed from the reformate gas, in the integrated piping module 20. The auto drain 21 has a structure in which, when a predetermined amount of liquid is gathered, the liquid is discharged out of the fuel cell system, due to the weight of the liquid, while preventing the discharge of the reformate gas. The auto drain 21 of FIG. 1 may indicate a plurality of auto drains.

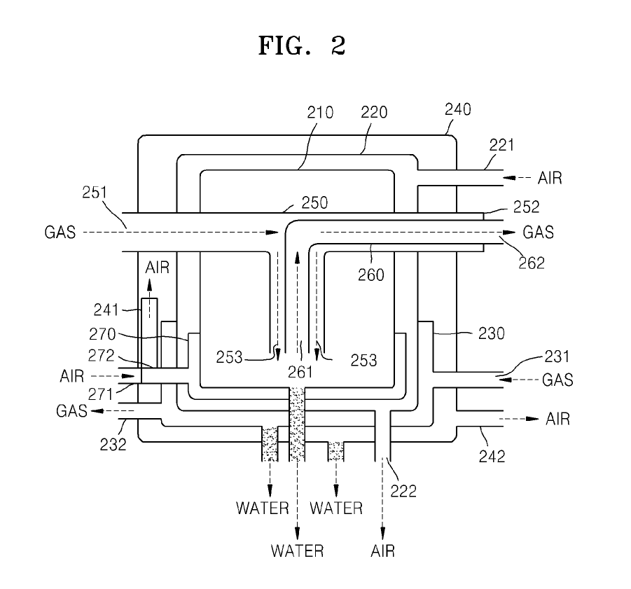

FIG. 2 is a cross-sectional view of the integrated piping module 20 of FIG. 1. However, the integrated piping module 20 of FIG. 1 is not limited to the example of FIG. 2, and thus, the configuration thereof may be modified. Referring to FIG. 2, the integrated piping module 20 includes a first tank 210, a second tank 220, a third tank 230, a fourth tank 240, an external pipe 250, an internal pipe 260, and a cooler 270. The first tank 210 is a cylindrical container. However, the first tank 210 may have various shapes.

Since the integrated piping module 20 may be formed as one body, joints for connecting various parts are not needed. Thus, the possibility of a gas leak, via joints between pipes and parts according to the related art, is eliminated. Also, a joint for connecting the fuel processor 10 and the fuel cell 30 may be replaced with one integrated piping module, so that the fuel cell system may be significantly miniaturized. It is also not necessary to include electronic valves or a control device for controlling the electronic valves.

The external pipe 250 is a T-shaped pipe having three ports. A first portion of the external pipe 250 penetrates horizontally through the first tank 210. A second portion of the external pipe 250 extends vertically from the first portion, within the first tank 210. Accordingly, ends of the first portion are disposed outside of the first tank 210. The first portion has an inlet 251, into which the reformate gas from the fuel processor 10 flows and an outlet 252 disposed at an opposing end of the first portion. The second portion has a middle outlet 253 disposed adjacent to the bottom of the first tank 210.

Accordingly, the external pipe 250 discharges the reformate gas inside of the first tank 210, via the middle outlet 253. The reformate gas is discharged from the fuel processor 10 at a temperature of about 120° C. to about 140° C. The reformate gas is cooled while passing between the inlet 251 and the middle outlet 253. Due to this cooling operation, water included in the reformate gas may be condensed, separated from the reformate gas and collected in the first tank 210.

The internal pipe 260 is disposed inside the external pipe 250 and includes an inlet 261 and an outlet 262. The internal pipe 260 extends between the middle outlet 253 and the outlet 252 of the external pipe 250, so as to transport the reformate gas from the first tank 210 to the anode plate of the fuel cell 30. The outlet 252 is sealed around the internal pipe 260, such that the reformate gas can only exit the outlet 252 by passing though the internal pipe 260. The outlet 262 is disposed inside of the outlet 252. The outlet 262 of the internal pipe 260 is disposed closer to the inlet 251 than to the middle outlet 253 of the external pipe 250, so that the reformate gas is cooled while passing between the inlet 251 and the middle outlet 253, so as to be dehumidified. The reformate gas is then heated while passing through the internal pipe 260, by the reformate gas passing through the external pipe 250.

In this manner, the external pipe 250 and the internal pipe 260 operate to separate the water from the reformate gas, so that it is not necessary to arrange a conventional drain separator. Thus, it is possible to reduce the size and complexity of the fuel cell system. Also, since the reformate gas passing through the internal pipe 260 is heated by the reformate gas passing through the inlet 251 of the external pipe 250, the reformate gas may be supplied to the fuel cell 30 at a high temperature, without using an external heating source. In other words, the external pipe 250 and the internal pipe 260 form a counter flow heating system.

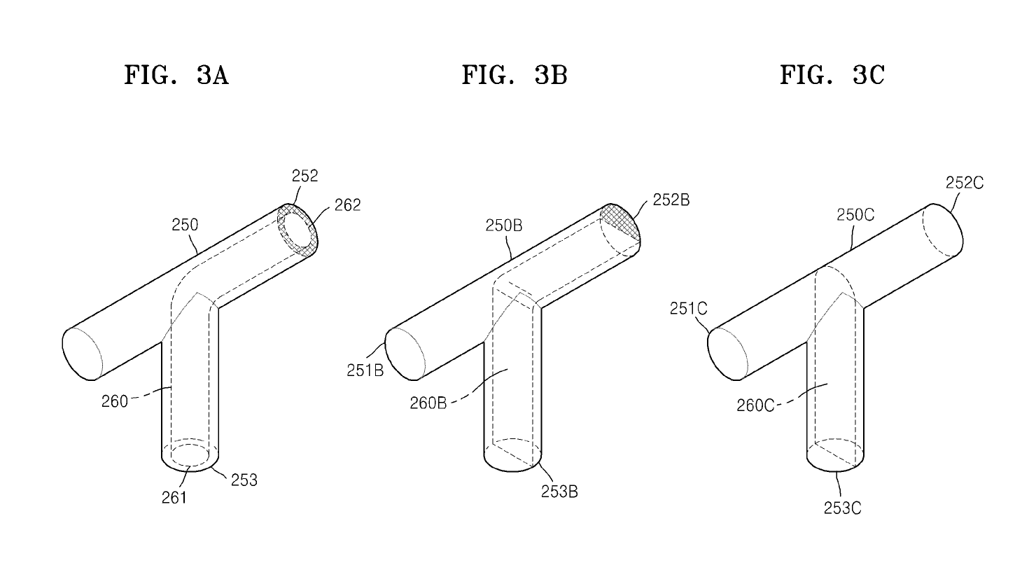

FIG. 3A illustrates the external pipe 250 and the internal pipe 260 of FIG. 2. FIGS. 3B and 3C illustrate modified external pipes, 250B, 250C and internal pipes 260B, 260C. Referring to FIG. 3A, the internal pipe 260 is cylindrical, is separated from an inner wall of the external pipe 250 by a regular distance, and extends between the middle outlet 253 and the outlet 252 of the external pipe 250.

Referring to FIG. 3B, an internal pipe 260B, in the form of an L-shaped partition 260B, is formed in the external pipe 250B. The partition 260B isolates an inlet 251B and an outlet 252B of the external pipe 250 and extends between a middle outlet 253B and the outlet 252B of the external pipe 250B.

Referring to FIG. 3C, an internal pipe 260C is in the form of a planar partition 260C isolating an inlet 251C and an outlet 252C of the external pipe 250C. The partition 260C extends from a middle outlet 253C of the external pipe 250C.

In FIG. 3A, the reformate gas enters the inlet 251 and then contacts the outer surface of the internal pipe 260, between the middle outlet 253 and the outlet 252, so the internal pipe 260 has the largest heated surface of the examples. On the other hand, in the example of FIG. 3C, the reformate gas enters the inlet 251C and contacts the planar partition 260C, so that a heating area of the internal pipe 260C is smallest among the examples. Thus, although it is very simple to manufacture the example of FIG. 3C, the example of FIG. 3C is less efficient at reheating the reformate gas, as compared to the other examples. It will be understood by one of ordinary skill in the art that, the external pipe 250 and the internal pipe 260 may be modified in various ways. The outlet 262 of the internal pipe 260 may be formed to be closer to the inlet 251 of the external pipe 250 than to the middle outlet 253 of the external pipe 250.

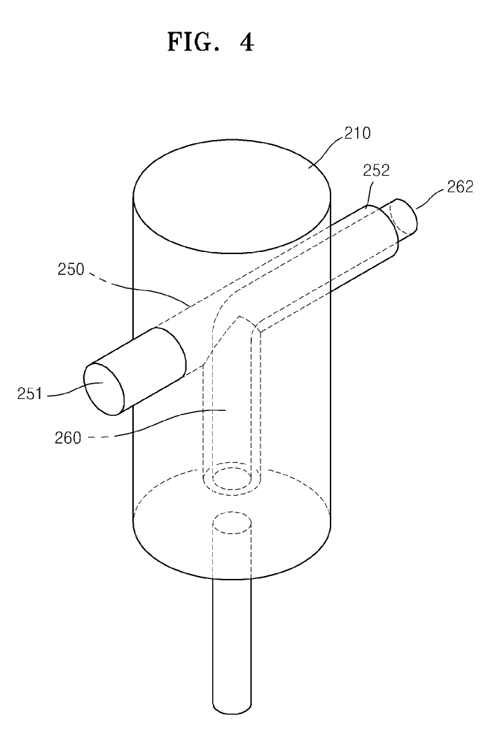

FIG. 4 is a diagram showing the first tank 210 and the example of FIG. 3A. Referring to FIG. 4, the reformate gas discharged from the middle outlet 253 of the external pipe 250 flows into the first tank 210. The reformate gas then flows into the inlet 261 of the internal pipe 260. The first tank 210 is otherwise sealed, so as to prevent the reformate gas from leaking out of the system. In particular, the first tank 210 condenses water and collects heat from the reformate gas. The heat collected by the first tank 210 heats the external pipe 250 and the internal pipe 260. The condensed water, that is, the water separated from the reformate gas, is gathered on the bottom in the first tank 210, and then is discharged to the auto drain 21.

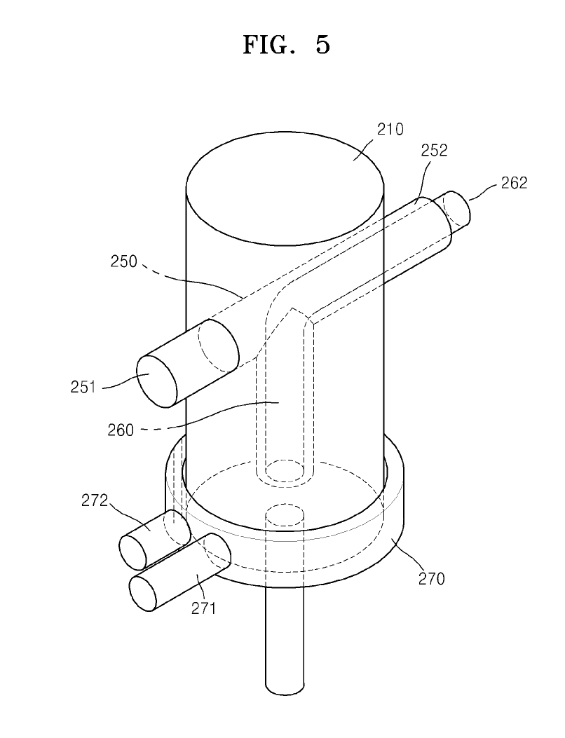

FIG. 5 is illustrates the cooler 270, in addition to the structure of FIG. 4. Referring to FIG. 5, the cooler 270 is positioned closer to the middle outlet 253 than to the inlet 251, of the external pipe 250. The cooler 270 cools a lower portion of the first tank 210, so as condense the water from the reformate gas. As a result, the cooler 270 also collects heat from the first tank 210.

In more detail, the cooler 270 is positioned adjacent to the middle outlet 253 and is annular. The cooler 270 surrounds the lower portion of the first tank 210. A coolant, such as low-temperature air flows into an inlet 271 of the cooler 270, goes around the lower portion of the first tank 210, and then is discharged via an outlet 272 of the cooler 270. Instead of the low-temperature air, the coolant may be water. Also, since a partition (not shown) is arranged between the inlet 271 and the outlet 272 of the cooler 270, air is prevented from flowing directly from the inlet 271 to the outlet 272.

The reformate gas is discharged from the middle outlet 253 of the external pipe 250 into the first tank 210. Due to the cooling operation of the cooler 270, the reformate gas is rapidly cooled, so that the water in the reformate gas may be condensed quickly in the first tank 210. If the external pipe 250 is sufficiently long in the vertical direction, such that the reformate gas may be satisfactorily cooled while passing between the inlet 251 the middle outlet 253, the cooler 270 may be omitted.

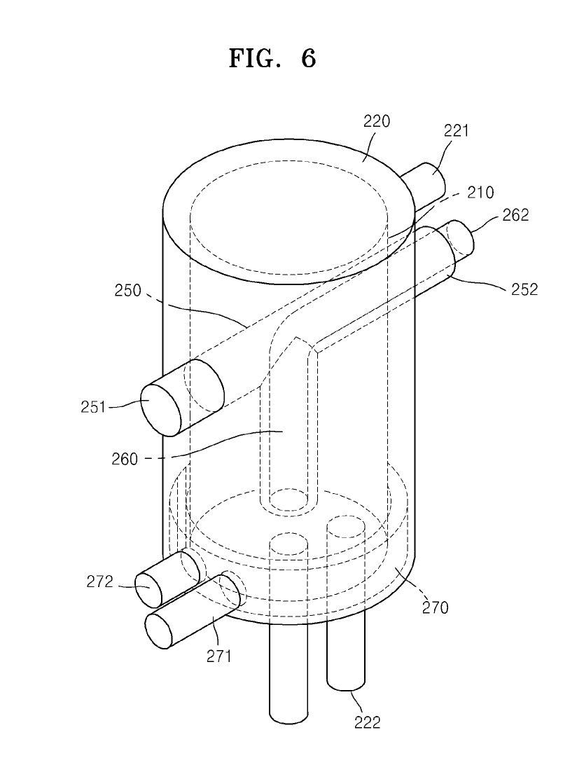

FIG. 6 is a diagram showing the second tank 220, in addition to the structure of FIG. 5. Referring to FIG. 6, the second tank 220 surrounds the first tank 210. The second tank 220 heats the first tank 210 using high-temperature air discharged from a cathode outlet of the fuel cell 30. In more detail, the second tank 220 is a cylindrical container surrounding the first tank 210. The high-temperature air discharged from the cathode outlet of the fuel cell 30 flows into an inlet 221 of the second tank 220, contacts the surface of the first tank 210, and then is discharged out of the second tank 220, via an outlet 222 of the second tank 220. Except for these openings, the second tank 200 otherwise sealed, so as to prevent the reformate gas from leaking out of the system. The second tank 220 may be a container having a different shape.

The second tank 220 of FIG. 6 collects heat from the air discharged from the cathode outlet of the fuel cell 30, which is then used to heat an upper portion of first tank 210. Due to a heat collecting operation of the second tank 220, the reformate gas in the first tank 210 may be heated sufficiently for used in the fuel cell 30. The reformate gas passes through the internal pipe 260, so that the heat loss of the fuel cell system of FIG. 1 may be decreased.

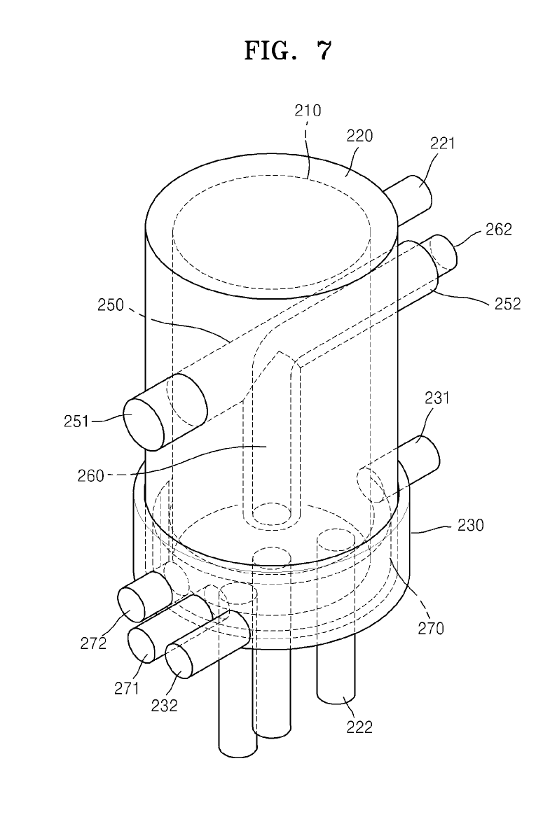

FIG. 7 is a diagram illustrating the third tank 230, in addition to the structure of FIG. 6. Referring to FIG. 7, the third tank 230 surrounds the cooler 270, so that the third tank 230 cools gas discharged from an anode outlet of the fuel cell 30, that is, an Anode Off Gas (AOG). Thus, water in the AOG can be condensed and removed. Accordingly, the third tank 230 collects heat from the AOG.

In more detail, the third tank 230 is an annular container surrounding the cooler 270 and a lower portion of the second tank 220. The AOG flows into an inlet 231 of the third tank 230, and is cooled by contacting a surface of the lower portion of the second tank 220, which contacts the cooler 270. Water condensed and separated from the AOG, via this cooling process. The water is then discharged through the auto drain 21, and the AOG is discharged to the fuel processor 10, via an outlet 232 of the third tank 230. The third tank 230 may have various other shapes. Also, a partition (not shown) may be arranged in the third tank 230 between the inlet 231 and the outlet 232 of the third tank 230, to insure that the AOG flows completely around the third tank 230.

The AOG discharged from the fuel cell 30 includes hydrogen and water. The AOG is used as a fuel for the burner of the fuel processor 10. In order for the AOG, to be used as a fuel for the burner, the water should be removed. Due to the cooling operation of the third tank 230, the water is separated from the AOG. Similar to the discharge operation in the first tank 210, the condensed water is discharged from the third tank 230 through the auto drain 21.

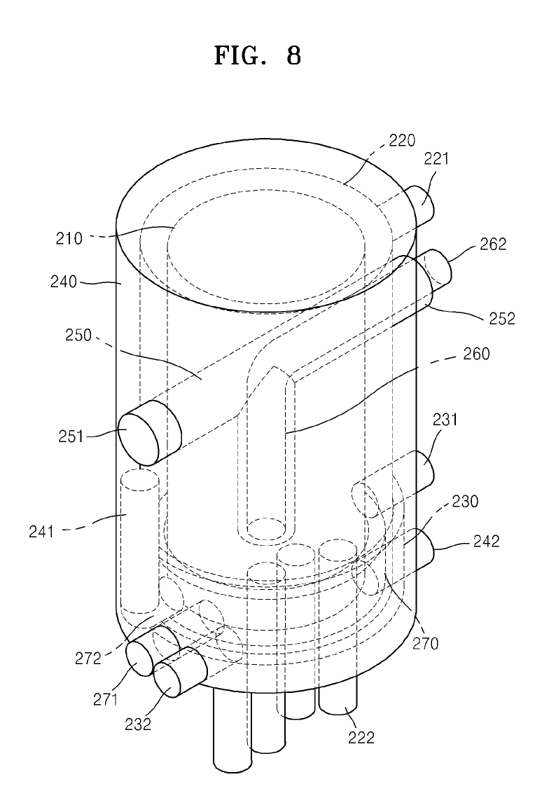

FIG. 8 is a diagram illustrating the fourth tank 240 in addition to the structure of FIG. 7. Referring to FIG. 8, the fourth tank 240 surrounds the first tank 210, the second tank 220, the cooler 270, and the third tank 230, so that the air discharged from an outlet 272 of the cooler 270 is heated by heat collected from each of the first tank 210, the second tank 220, and the third tank 230.

In more detail, the fourth tank 240 is a cylindrical container. The heat collected by the cooler 270 is discharged from the outlet 272 of the cooler 270, and then flows toward an upper portion of the fourth tank 240, via a pipe 241 arranged in the fourth tank 240. The discharged air is heated by the first tank 210, the second tank 220, and the third tank 230, while flowing toward a lower portion of the fourth tank 240, and then is discharged to a cathode inlet of the fuel cell 30, via an outlet 242 of the fourth tank 240. The fourth tank 240 may have various other shapes.

Also, a partition (not shown) may be arranged in the fourth tank 240, in such a way that the air discharged toward the upper portion of the fourth tank 240, via the pipe 241, may be uniformly spread out in the fourth tank 240, while flowing toward the lower portion of the fourth tank 240. When the fuel cell 30 is stopped and a predetermined time passes, water generated by the cathode plate of the fuel cell 30 is condensed and is discharged from the cathode inlet of the fuel cell 30. The condensed water may be discharged through the outlet 242 of the fourth tank 240. In this case, the condensed water gathered in the fourth tank 240 may be discharged through the auto drain 21.

The fourth tank 240 of FIG. 8 collects the heat emitted from the air discharged from the outlet 272 of the cooler 270, and then delivers the heat to the first through third tanks 210, 220, and 230 in the fourth tank 240. The fourth tank 240 lastly collects the heat emitted from the integrated piping module 20 of FIG. 2, thereby maintaining the heat of the fuel cell system of FIG. 1.

According to the one or more exemplary embodiments, pipes connecting the fuel processor and the fuel cell may be integrated, so reduce the complexity of the system and reducing the possibility of leakage. In addition, the heat loss in the fuel cell system may be minimized. Since water is removed from the reformate gas in one or more tanks and discharged, the reformate gas generated in the fuel processor may be supplied at a high temperature to the fuel cell, without much heat loss.

It should be understood that the exemplary embodiments described therein should be considered in a descriptive sense only and not for purposes of limitation. Descriptions of features or aspects within each embodiment should typically be considered as available for other similar features or aspects in other embodiments.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. An integrated piping module comprising:
a first tank;
an external pipe to transfer a fluid from a source to a fuel cell, the external pipe having:
a first portion that extends through the first tank, having an inlet connected to the source, and an outlet; and
a second portion that extends from the first portion, having a middle outlet disposed in the first tank; and
an internal pipe that extends from the middle outlet, inside the external pipe, out of the outlet, and to the fuel cell, wherein,
the fluid flows through the external pipe into the first tank, and then through the internal pipe to the fuel cell,
water is condensed from the fluid and collected in the first tank, and
an outlet of the internal pipe is disposed closer to the inlet of the external pipe than to the middle outlet of the external pipe, and
the fluid flowing in the internal pipe is heated by the fluid flowing in the external pipe.

2. The integrated piping module of claim 1, further comprising a second tank surrounding the first tank, to heat a portion of the first tank, using a fluid discharged from a fuel cell.

3. The integrated piping module of claim 1, further comprising a cooler disposed around the first tank, adjacent to the middle outlet, to cool the first tank.

4. The integrated piping module of claim 3, further comprising a third tank surrounding the cooler, to cool gas discharged from the fuel cell, to remove water from the gas.

5. The integrated piping module of claim 4, further comprising a fourth tank surrounding the third tank, to heat the third tank using fluid discharged from the cooler.

6. The integrated piping module of claim 1, wherein the internal pipe is cylindrical and spaced apart from an inner surface of the external pipe, by a regular distance.

7. A fuel cell system comprising:
a fuel processor to convert a fuel into a reformate gas;
a fuel cell to generate power using the reformate gas; and
an integrated piping module to connect the fuel processor and the fuel cell and remove water from the reformate gas, the integrated piping module comprising:
a tank collect water condensed from the reformate gas; and
pipes to heat and cool the reformate gas, to discharged water from the tanks, and to connect the tanks to the fuel processor and the fuel cell.

8. The fuel cell system of claim 7, further comprising a tank to heat the reformate gas, using an air discharged from the fuel cell.

9. The fuel cell system of claim 8, further comprising a tank to condense water from anode off gas from the fuel cell.

10. The fuel cell system of claim 7, wherein the pipes comprise a pipe to remove the water from the tank, and a pipe to heat the reformate gas from which the water is removed.

11. The fuel cell system of claim 7, further comprising an auto drain to externally discharge the water removed from the reform gas.

12. The fuel cell system of claim 7, further comprising a bypassing apparatus to selectively supplying the reformate gas to the integrated piping module, according to a concentration of a component in the reformate gas.
